(19) United States
(12) Patent Application Publication
(10) Pub. No.: US 2023/0351325 A1
(43) Pub. Date: Nov. 2, 2023

(54) PARTS PROCUREMENT SUPPORT DEVICE, PARTS PROCUREMENT SUPPORT SYSTEM, AND PARTS PROCUREMENT SUPPORT METHOD

(71) Applicant: Hitachi, Ltd., Tokyo (JP)

(72) Inventors: Maho URANO, Tokyo (JP); Koji UTSUMI, Tokyo (JP); Tazu NOMOTO, Tokyo (JP); Kenji OYA, Tokyo (JP)

(21) Appl. No.: 18/116,921

(22) Filed: Mar. 3, 2023

(30) Foreign Application Priority Data
Apr. 27, 2022 (JP) 2022-073710

(51) Int. Cl. G06Q 10/0875

(52) U.S. Cl. CPC G06Q 10/0875

(57) ABSTRACT

A parts procurement support device including: a similar product selection unit that selects an existing product similar to a new product on the basis of shared information regarding design of the new product and feature information indicating a feature of the existing product; and a supplier selection unit that selects a supplier of a part constituting the new product on the basis of parts information regarding a part of the selected existing product.

### CROSS-REFERENCE TO RELATED APPLICATION

The present application claims priority from Japanese application JP2022-073710, filed on Apr. 27, 2022, the contents of which is hereby incorporated by reference into this application.

### BACKGROUND

### Technical Field

The present invention relates to a parts procurement support device, a parts procurement support system, and a parts procurement support method.

### Related Art

In the manufacturing industries and the like, a design department creates a plan for specifications of a new product, and determines the design of the new product, on the basis of planning information including the contents of the plan. After the design of the new product is completed as described above, a procurement department determines the suppliers of parts constituting the new product. In general, for example, a person in charge of the design department prepares documents such as a bill of materials (BOM) and a manufacturing instruction on the basis of design drawing information, and a person in charge of the procurement department selects part suppliers on the basis of the BOM and the design information in the manufacturing instruction.

For example, JP 2021-125135 A discloses a system that automatically bids for selecting a part manufacturer to be a supplier after finishing design of a new product.

### SUMMARY

However, the technique described in JP 2021-125135 A is premised on the design information of the product determined to be commercialized, and thus it is not possible to select a supplier in parallel with product development. For this reason, it is difficult for the procurement department to secure sufficient time for selection of suppliers. Further, it is not possible to perform timely procurement according to the progress of development.

In addition, JP 2021-125135 A is based on the premise that the design information includes the information on a BOM. However, at an early stage of product development in which planning information is generated, parts to be used in the product and the numbers of thereof may not be determined. Therefore, in the technology described in JP 2021-125135 A, it is not possible to determine part suppliers from the viewpoint of whether the quantities of parts used in the product can be supplied or whether the prices of the parts are less expensive.

The present invention has been made in view of such circumstances, and an object of the present invention is to enable early selection of part suppliers.

The present application includes a plurality of means for solving at least some of the above problems, and examples thereof are as follows.

In order to solve the above problems, a parts procurement support device according to an aspect of the present invention includes: a similar product selection unit that selects an existing product similar to a new product on the basis of shared information regarding design of the new product and feature information indicating a feature of the existing product; and a supplier selection unit that selects a supplier of a part constituting the new product on the basis of parts information regarding a part of the selected existing product.

According to one aspect of the present invention, it is possible to select part suppliers at an early stage.

### BRIEF DESCRIPTION OF DRAWINGS

FIG. 1 is a schematic diagram illustrating an example of a system configuration of a parts procurement support system according to an embodiment;

FIG. 2 is a schematic diagram illustrating an example of shared information;

FIG. 3 is a schematic diagram illustrating an example of evaluation information;

FIG. 4 is a schematic diagram illustrating an example of managing post information;

FIG. 5 is a schematic diagram illustrating an example of an idea evaluation list;

FIG. 6 is a schematic diagram illustrating an example of threshold information;

FIG. 7 is a schematic diagram illustrating an example of evaluation result information;

FIG. 8 is a schematic diagram illustrating an example of keyword information;

FIG. 9 is a schematic diagram illustrating an example of a similar product evaluation list;

FIG. 10 is a schematic diagram illustrating an example of existing product parts information;

FIG. 11 is a schematic diagram illustrating an example of supplier information;

FIG. 12 is a schematic diagram illustrating an example of new product parts information;

FIG. 13 is a schematic diagram illustrating an example of supplier candidate information;

FIG. 14 is a sequence diagram illustrating an example of a parts procurement support method according to an embodiment;

FIG. 15 is a diagram illustrating an example of determination results presented on a terminal device;

FIG. 16 is a diagram illustrating an example of results including existing products and suppliers presented on the terminal device;

FIG. 17 is a flowchart illustrating an example of a new product adoption determination process;

FIG. 18 is a flowchart illustrating an example of a similar product selection process;

FIG. 19 is a flowchart illustrating an example of a supplier candidate selection process;

FIG. 20 is a schematic diagram illustrating an example of product planning information; and

FIG. 21 is a diagram illustrating an example of a hardware configuration of a parts procurement support device according to an embodiment.

### DETAILED DESCRIPTION

Hereinafter, an embodiment according to the present invention will be described with reference to the drawings. In all the drawings for describing the embodiments, the same members are denoted by the same reference numerals in principle, and repeated description thereof will be omitted as appropriate. In the following embodiments, it goes without saying that the components (including element steps and the like) are not necessarily essential unless otherwise specified or considered to be obviously essential in principle. In addition, it goes without saying that the terms “consisting of A”, “made up of A”, “having A”, and “including A” do not exclude other elements unless it is specifically stated that A is the one and only element. Similarly, in the following embodiments, when referring to the shapes, positional relationships, and the like of the components and the like, it is assumed that those substantially approximate or similar to the shapes and the like are included unless otherwise stated or unless clearly considered in principle.

### First Embodiment

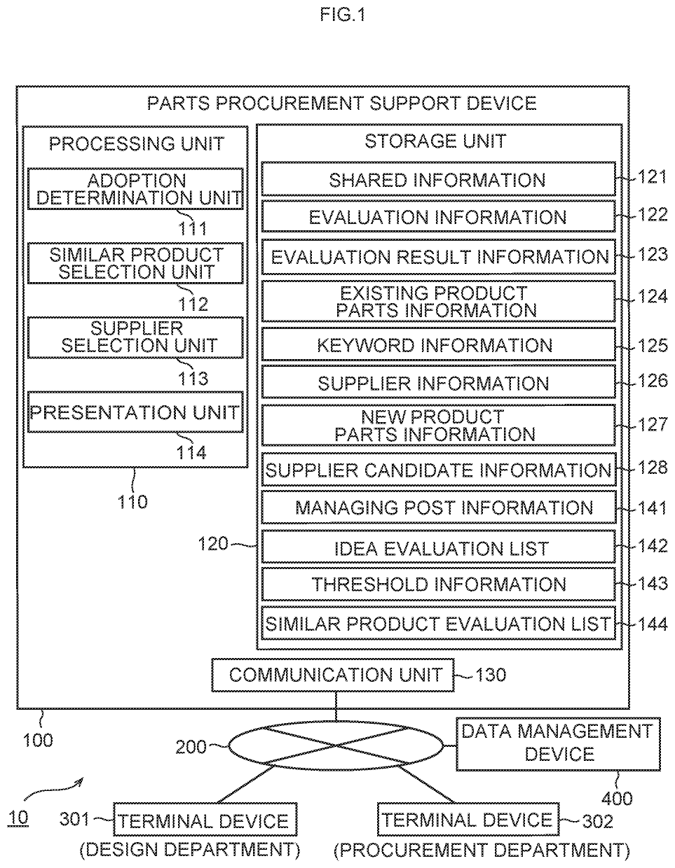

FIG. 1 is a schematic diagram illustrating an example of a system configuration of a parts procurement support system according to the present embodiment.

A parts procurement support system 10 is a system for selecting a part supplier at an early stage at a product design stage, and includes a parts procurement support device 100, terminal devices 301 and 302, and a data management device 400. These devices are connected to each other via a network 200 such as the Internet or a local area network (LAN).

The terminal devices 301 and 302 are computers such as personal computers (PCs), smartphones, and tablet terminals. The terminal device 301 is under the control of the design department, and the terminal device 302 is under the control of the procurement department.

The data management device 400 is a computer including a storage device that stores data, and is a computer constituting a product data management (PDM) system, for example.

The parts procurement support device 100 is a computer such as a physical server, a virtual server, or a PC. For example, the parts procurement support device 100 presents suppliers of parts of a new product, on the basis of shared information 121 including an idea and CAD (computer aided design) data of the new product shared among persons in charge of the design department of a certain business operator. As an example, the parts procurement support device 100 includes a processing unit 110, a storage unit 120, and a communication unit 130.

The communication unit 130 is an interface for connecting the parts procurement support device 100 to the network 200.

The processing unit 110 is a functional unit that controls each unit of the parts procurement support device 100. For example, the processing unit 110 includes an adoption determination unit 111, a similar product selection unit 112, a supplier selection unit 113, and a presentation unit 114.

The adoption determination unit 111 is a functional unit that evaluates predetermined items included in the shared information 121 to determine whether a new product devised by a person in charge of the design department will be adopted as a product.

The similar product selection unit 112 is a processing unit that selects an existing product similar to the new product among a plurality of existing products, on the basis of the shared information 121. Each of the plurality of existing products is a product commercialized in the past by the business operator who has developed the new product, for example.

The supplier selection unit 113 is a functional unit that selects suppliers of parts constituting the new product, on the basis of information on the numbers of parts constituting an existing product.

The presentation unit 114 is a functional unit that presents the suppliers selected by the supplier selection unit 113 on the terminal devices 301 and 302.

The storage unit 120 is a functional unit that stores various types of information. As an example, the storage unit 120 stores the shared information 121, evaluation information 122, evaluation result information 123, existing product parts information 124, keyword information 125, and supplier information 126. The storage unit 120 further stores new product parts information 127, supplier candidate information 128, managing post information 141, an idea evaluation list 142, threshold information 143, and a similar product evaluation list 144.

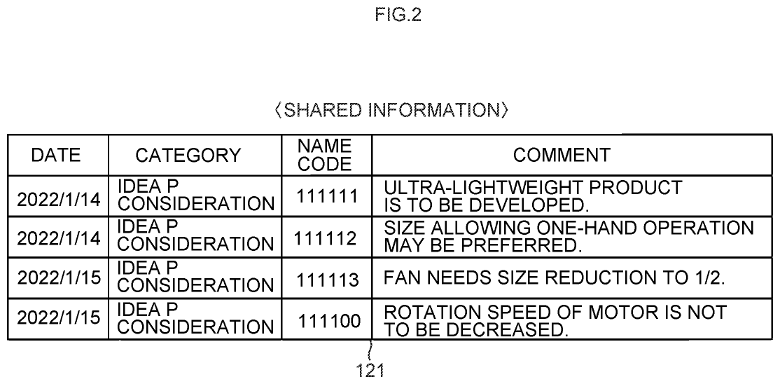

FIG. 2 is a schematic diagram illustrating an example of the shared information 121.

The shared information 121 is information regarding design of a new product, and is information including texts extracted from a chat between persons in charge in the design department of a certain business operator. Texts may be extracted from emails or telephone conversations instead of chat. Since chat, emails, and telephone conversations are firsthand information exchanged between persons in charge at the time of development of a new product, the shared information 121 can include undocumented vivid information regarding the new product.

In this example, the terminal device 301 managed by the design department extracts texts indicating “DATE”, “CATEGORY”, “NAME CODE”, and “COMMENT” included in the chat by using machine learning, and generates the shared information 121 including these texts. A computer outside the parts procurement support system 10 may generate the shared information 121.

The “DATE” is the date on which the chat was performed. The “CATEGORY” is a classification category of ideas of a new product included in the chat. For example, if a chat was performed on an idea P, the character string “CONSIDERATION OF THE IDEA P” is stored in the “CATEGORY”. The “NAME CODE” is the code for identifying the person in charge who has sent the chat. The “COMMENT” is the comment sent by the person in charge in the chat.

The shared information 121 may also include various electronic files related to a new product. Such electronic files include, in addition to the CAD data described above, electronic files of documents required in the company at the time of commercialization of the new product.

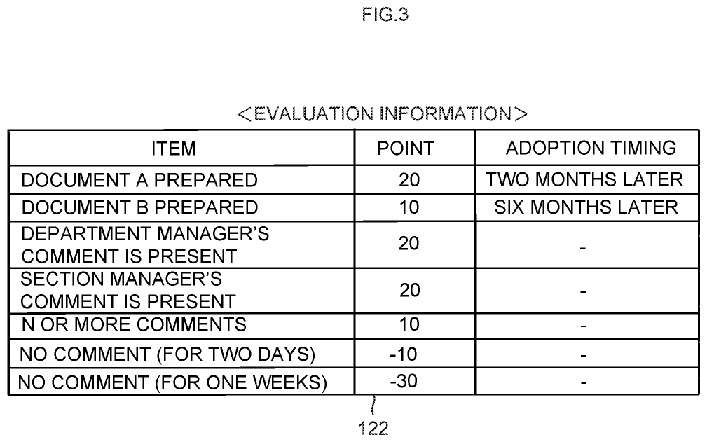

FIG. 3 is a schematic diagram illustrating an example of the evaluation information 122.

The evaluation information 122 is information for evaluating the degree of possibility that a new product is adopted. In this example, the evaluation information 122 is information on “ITEM”, “POINT”, and “ADOPTION TIME” associated with each other.

The “ITEM” is an evaluation item specified from the shared information 121. For example, the “DOCUMENT A PREPARED” is an item for determining whether the electronic file of “DOCUMENT A” is included in the shared information 121 or whether it can be confirmed from the content of “COMMENT” of the shared information 121 that “DOCUMENT A” has been prepared. The “DOCUMENT A” is a document that is essential for a company to commercialize a new product. The same applies to the “DOCUMENT B”.

The “DEPARTMENT MANAGER'S COMMENT IS PRESENT” is an item for determining whether the department manager's comment is present on the basis of the “NAME CODE” of the shared information 121. Similarly, the “SECTION MANAGER'S COMMENT IS PRESENT” is an item for determining whether the section manager's comment is present.

The “N OR MORE COMMENTS” is an item for determining whether N or more “COMMENT” related to one and the same idea have appeared in the evaluation information 122.

The “NO COMMENT (TWO DAYS)” is an item for determining whether no “COMMENT” related to one and the same idea has appeared for two consecutive days. Similarly, the “NO COMMENT (ONE WEEK)” is an item for determining whether no “COMMENT” related to one and the same idea has appeared for one week.

The “POINT” is a numerical value assigned to each of the “ITEM”, which indicates a possibility that a new product will be adopted as a commercial product. In this example, as the “POINT” is higher, the possibility of adopting a new product increases. For example, if the “DOCUMENT A” is important for commercialization of a new product, the point corresponding to the item “DOCUMENT A PREPARED” is set to as high as “20”.

In addition, if there is a comment made by an approver such as a section manager or a department manager, there is a high possibility that a new product will be adopted as a commercial product. Therefore, the points corresponding to the item of “DEPARTMENT MANAGER'S COMMENT IS PRESENT” and “SECTION MANAGER'S COMMENT IS PRESENT” are also set to as high as “20”. On the other hand, if no comment is made for a long period, the idea is left untouched, and there is a low possibility that a new product will be adopted as a commercial product. Therefore, the point of “NO COMMENT (TWO DAYS)” is set to as low as “−10”, and the point of “NO COMMENT (ONE WEEK)” is further set to as low as “−30”.

The “ADOPTION TIMING” is a timing at which a new product is expected to be adopted as a commercial product because the “DOCUMENT A” or the “DOCUMENT B” has been prepared. In this example, the “DOCUMENT A” is an essential document for commercialization, and if the “DOCUMENT A” has been prepared, it is considered that there is a very high possibility of commercialization. Thus, the “ADOPTION TIMING” corresponding to the “DOCUMENT A PREPARED” is set to “TWO MONTHS LATER”. On the other hand, the “DOCUMENT B” is considered to be less important than the “DOCUMENT A”. Thus, the “ADOPTION TIMING” corresponding to the “DOCUMENT B PREPARED” is set to “SIX MONTHS LATER”.

The administrator of the parts procurement support system 10 manually generates the evaluation information 122 and stores the same in the data management device 400 in advance. Then, the parts procurement support device 100 acquires the evaluation information 122 from the data management device 400 as necessary, and stores the same in the storage unit 120. The parts procurement support system 10 may automatically generate the evaluation information 122 on the basis of past results.

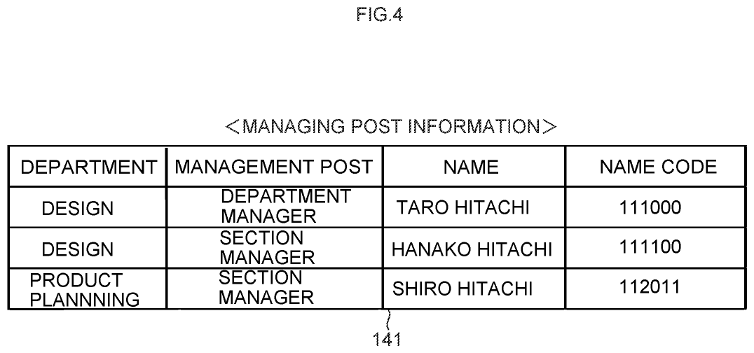

FIG. 4 is a schematic diagram illustrating an example of the managing post information 141.

The managing post information 141 is information for specifying the managing post from the “NAME CODE” in the shared information 121 (see FIG. 2). As an example, the managing post information 141 is information in which “DEPARTMENT”, “MANAGING POST”, “NAME”, and “NAME CODE” are associated with one another.

For example, if a certain “COMMENT” in the shared information 121 is associated with “NAME CODE” “111000”, it can be seen from FIG. 4 that the “COMMENT” is a comment made by the department manager. As a result, the adoption determination unit 111 can determine whether the item “DEPARTMENT MANAGER'S COMMENT IS PRESENT” in the evaluation information 122 (see FIG. 3) is satisfied.

The administrator of the parts procurement support system 10 manually generates the managing post information 141 and stores the same in the data management device 400 in advance. Then, the parts procurement support device 100 acquires the managing post information 141 from the data management device 400 as necessary, and stores the same in the storage unit 120.

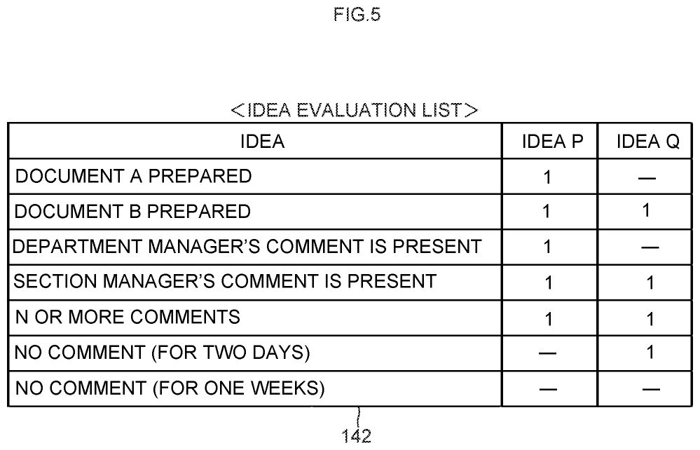

FIG. 5 is a schematic diagram illustrating an example of the idea evaluation list 142.

The idea evaluation list 142 is information obtained by determining the satisfaction or dissatisfaction of each “ITEM” of the evaluation information 122 (see FIG. 3) in each “CATEGORY” of the shared information 121 (see FIG. 2). If the “ITEM” is satisfied, the adoption determination unit 111 records “1” in a column corresponding to the item, and if the “ITEM” is not satisfied, the adoption determination unit 111 records “-” in the column.

In the present embodiment, the sum of points (see FIG. 4) of “ITEM” for which “1” is recorded in the idea evaluation list 142 is set as adoption point. For example, the adoption point of “IDEA P” is 20+10+20+20+10=80. On the other hand, the adoption point of “idea Q” is 10+20+10+(−10)=30.

The adoption point is a numerical value indicating a possibility that a new product will be finally adopted as a commercial product. In this example, the new product of the “IDEA P” is more likely to be adopted as a commercial product than the new product of the “IDEA Q”.

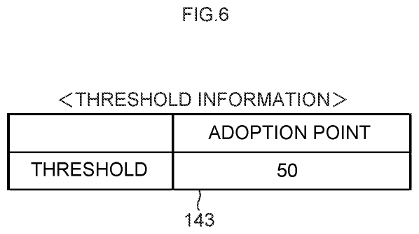

FIG. 6 is a schematic diagram illustrating an example of the threshold information 143.

The threshold information 143 is information storing a threshold for the adoption point. The threshold is a value serving as a reference for the adoption determination unit 111 to determine whether a new product to be adopted as a commercial product. Here, if the adoption point becomes equal to or greater than the threshold, the adoption determination unit 111 determines that the new product will be adopted as a commercial product. If the adoption point is less than the threshold, the adoption determination unit 111 determines that the new product will not be adopted as a commercial product.

In the example of FIG. 6, the threshold is set to “50”. Therefore, as described above, if the adoption point of the “IDEA P” is “80” and the adoption point of the “IDEA Q” is “30”, the adoption determination unit 111 determines that the new product of the “IDEA P” will be adopted as a commercial product and the new product of the “IDEA Q” will not be adopted as a commercial product.

Since the adoption point indicates a high possibility that a new product will be adopted as a commercial product, the adoption determination unit 111 can accurately determine whether the new product is to be adopted by determining whether the value is equal to or more than the threshold.

The administrator of the parts procurement support system 10 stores the threshold information 143 including the threshold determined by himself/herself in the data management device 400 in advance. Then, the parts procurement support device 100 acquires the threshold information 143 from the data management device 400 as necessary, and stores the threshold information in the storage unit 120.

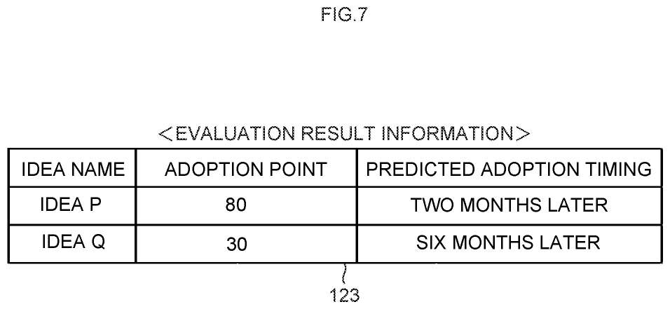

FIG. 7 is a schematic diagram illustrating an example of the evaluation result information 123.

The evaluation result information 123 is information indicating results of evaluation by the adoption determination unit 111 on whether a new product is to be adopted as a commercial product. The evaluation result information 123 here is information in which the “IDEA NAME”, the “ADOPTION POINT”, and the “PREDICTED ADOPTION TIMING” are associated with one another.

The “IDEA NAME” is a name of an idea of a new product and corresponds to the “CATEGORY” of the shared information 121. The “ADOPTION POINT” is the sum of the points (see FIG. 4) of the “ITEM” for which “1” is recorded in the idea evaluation list 142 as described above.

The “PREDICTED ADOPTION TIMING” corresponds to the “ADOPTION TIMING” in the evaluation information 122 (see FIG. 3). If “1” is recorded in the item “DOCUMENT A PREPARED” in the idea evaluation list 142 (see FIG. 5), the adoption determination unit 111 records “TWO MONTHS LATER” in “PREDICTED ADOPTION TIMING” in the evaluation result information 123. On the other hand, if “1” is recorded in the item “DOCUMENT B PREPARED” in the idea evaluation list 142 (see FIG. 5), the adoption determination unit 111 records “SIX MONTHS LATER” in “PREDICTED ADOPTION TIMING” in the evaluation result information 123. If “1” is recorded in both items of “DOCUMENT A PREPARED” and “DOCUMENT B PREPARED”, the adoption determination unit 111 records “TWO MONTHS LATER”, which is earlier timing, in “PREDICTED ADOPTION TIMING”.

The adoption determination unit 111 records the items corresponding to the new product (idea P) of which the adoption point exceeds the threshold in the evaluation result information 123. However, for reference of the user, the adoption determination unit 111 may record the item corresponding to the new product (idea Q) of which the adoption point is equal to or less than the threshold in the evaluation result information 123.

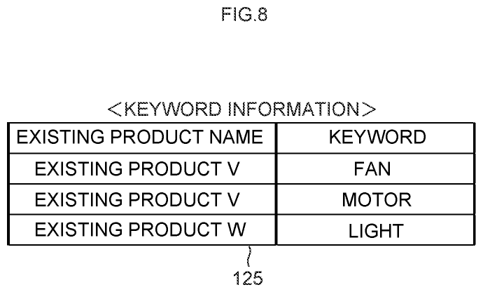

FIG. 8 is a schematic diagram illustrating an example of the keyword information 125.

The keyword information 125 is an example of feature information of existing products, and is information in which “EXISTING PRODUCT NAME” and “KEYWORD” are associated with each other. The “EXISTING PRODUCT NAME” is the name of an existing product that has been commercialized in the past by the same business operator that has generated the shared information 121.

The “KEYWORD” is a character string indicating a feature of an existing product, and is the name of a part constituting the existing product, for example. If an existing product includes a plurality of different parts, all of the names of these parts are keywords of the existing product, and the plurality of keywords is associated with one existing product. Instead of or in addition to the name of the part constituting the existing product, the specification or design of the existing product may be used as the “KEYWORD”.

For example, since the “EXISTING PRODUCT V” includes parts of a fan and a motor, two keywords “FAN” and “MOTOR” correspond to the “EXISTING PRODUCT V”. Note that the keywords in the keyword information 125 are examples of a first keyword.

The administrator of the parts procurement support system 10 manually generates the keyword information 125 and stores the same in the data management device 400 in advance. Then, the parts procurement support device 100 acquires the keyword information 125 from the data management device 400 as necessary, and stores the same in the storage unit 120. The parts procurement support system 10 may automatically generate the keyword information 125.

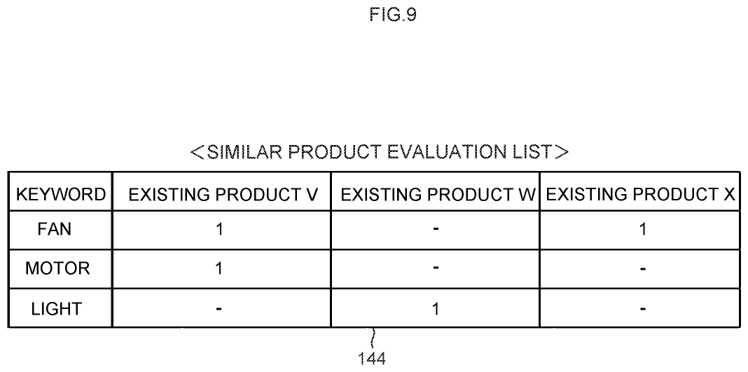

FIG. 9 is a schematic diagram illustrating an example of the similar product evaluation list 144.

The similar product evaluation list 144 is information indicating, for each existing product, whether a keyword matching the “KEYWORD” in the keyword information 125 has appeared in the “COMMENT” belonging to a certain “CATEGORY” in the shared information 121 (see FIG. 2). If the “KEYWORD” has appeared in the “COMMENT”, the similar product selection unit 112 records “1” in the similar product evaluation list 144, and if the “KEYWORD” has not appeared, the similar product selection unit 112 records “-”. Note that the “KEYWORD” appearing in the shared information 121 is an example of a second keyword.

In the example of FIG. 9, “FAN”, “MOTOR”, and “LIGHT” have appeared in any of a plurality of “COMMENT” belonging to the “CATEGORY” of the “IDEA P” in the shared information 121 (see FIG. 2). According to the keyword information 125, the keywords of the “EXISTING PRODUCT V” are “FAN” and “MOTOR”. Therefore, the similar product selection unit 112 records “1” in each of the fields of “FAN” and “MOTOR” corresponding to the “EXISTING PRODUCT V” in the similar product evaluation list 144. On the other hand, “LIGHT” does not exist as a keyword of the “EXISTING PRODUCT V”. Therefore, the similar product selection unit 112 records “-” in the field of “LIGHT” corresponding to “EXISTING PRODUCT V” in the similar product evaluation list 144.

The similar product selection unit 112 similarly fills the respective fields of “EXISTING PRODUCT W” and “EXISTING PRODUCT X”.

In the present embodiment, the similar product selection unit 112 determines the number of “1” in the similar product evaluation list 144 for each existing product. The number of “1” is the number of parts in common between the new product and the existing product. It is considered that the existing product having a larger number of “1” has more parts in common with the new product and is similar to the new product. Therefore, the similar product selection unit 112 determines that the existing product having the largest number of “1s” among the plurality of existing products is similar to the new product having the idea corresponding to the similar product evaluation list 144. In the example of FIG. 9, the “EXISTING PRODUCT V” has the largest number of “1s” among the “EXISTING PRODUCT V”, the “EXISTING PRODUCT W”, and the “EXISTING PRODUCT X”. Therefore, the similar product selection unit 112 determines that the new product of the “IDEA P” is similar to the “EXISTING PRODUCT V”.

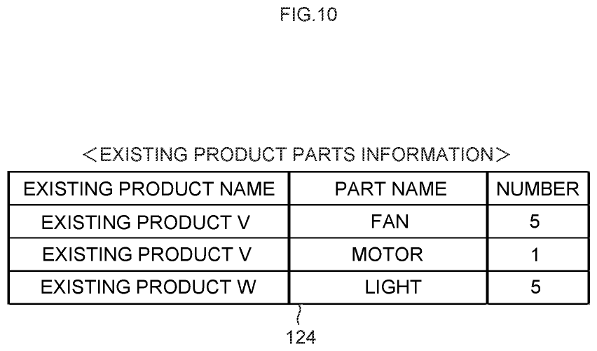

FIG. 10 is a schematic diagram illustrating an example of the existing product parts information 124.

The existing product parts information 124 is an example of parts information on parts of an existing product, and is information indicating parts constituting the existing product and the numbers of the parts. In the example of FIG. 10, the “EXISTING PRODUCT V” includes five fans and one motor.

The administrator of the parts procurement support system 10 manually generates the existing product parts information 124 and stores the information in the data management device 400 in advance. Then, the parts procurement support device 100 acquires the existing product parts information 124 from the data management device 400 as necessary, and stores the same in the storage unit 120. The parts procurement support system 10 may automatically generate the existing product parts information 124.

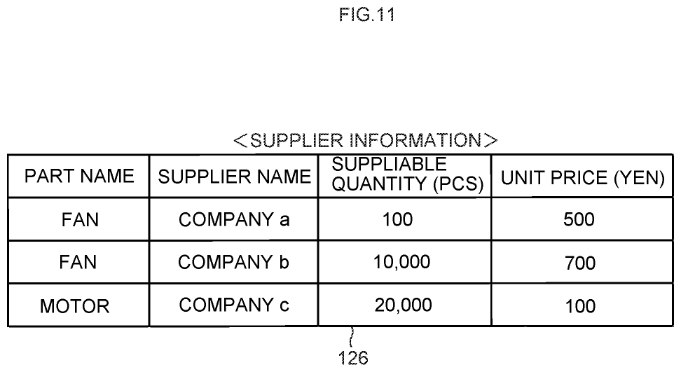

FIG. 11 is a schematic diagram illustrating an example of the supplier information 126.

The supplier information 126 is information in which “PART NAME”, “SUPPLIER NAME”, “SUPPLIABLE QUANTITY”, and “UNIT PRICE” are associated with one another.

The “SUPPLIER NAME” is the name of a supplier that can supply a certain part. For example, the part “FAN” can be supplied from “COMPANY a” and “COMPANY b”. The “SUPPLIABLE QUANTITY” is the number of parts that can be procured from a certain supplier per year. The number of parts that can be procured per month or per week instead of per year may be set as the “SUPPLIABLE QUANTITY”. The “UNIT PRICE” is a price per part at a certain supplier.

The administrator of the parts procurement support system 10 manually generates the supplier information 126 and stores the same in the data management device 400 in advance. Then, the parts procurement support device 100 acquires the supplier information 126 from the data management device 400 as necessary, and stores the same in the storage unit 120. The parts procurement support system 10 may automatically generate the supplier information 126.

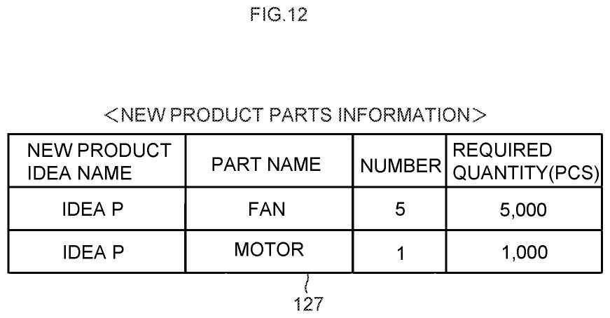

FIG. 12 is a schematic diagram illustrating an example of the new product parts information 127.

The new product parts information 127 is information obtained by the supplier selection unit 113 estimating the numbers of parts constituting a new product determined by the adoption determination unit 111 to be adopted as a commercial product and the required quantities of the parts.

In this example, the new product parts information 127 is information in which “PART NAME”, “NUMBER”, and “REQUIRED QUANTITY” are associated with one another. For example, the case where it is determined that the new product of “IDEA P” is to be adopted as a commercial product as described above, and it is determined that the new product is similar to the “EXISTING PRODUCT V” on the basis of the similar product evaluation list 144 will be considered.

In this case, it is considered that the parts constituting the new product and the numbers thereof are similar to the parts constituting the “EXISTING PRODUCT V” and the numbers thereof. According to the existing product parts information 124, the number of “FAN” of the “EXISTING PRODUCT V” is five, and the number of “MOTOR” is one. Therefore, the supplier selection unit 113 can estimate that the parts constituting the new product are also “FAN” and “MOTOR”, and the number of the “FAN” is five and the number of the “MOTOR” is one in the new product. The supplier selection unit 113 thus records “5” as the number of “FAN” of “IDEA P”, and records “1” as the number of “MOTOR” in the new product parts information 127.

The “REQUIRED QUANTITY” of the new product parts information 127 is estimated by the supplier selection unit 113 from the planned production volume of the new product that is implied in a comment of the shared information 121 (see FIG. 2). For example, it is assumed that the shared information 121 includes a comment implying that the planned production volume of the new product of the “IDEA P” is 1,000 in any of a plurality of “COMMENT” of which the “CATEGORY” belongs to the “IDEA P”. In this case, the supplier selection unit 113 stores a value obtained by multiplying the number of each part by the planned production volume of the part (1,000) as the necessary number in the “REQUIRED QUANTITY” of the new product parts information 127. For example, since the number of “FAN” is “5”, the required quantity of “FAN” is 5,000.

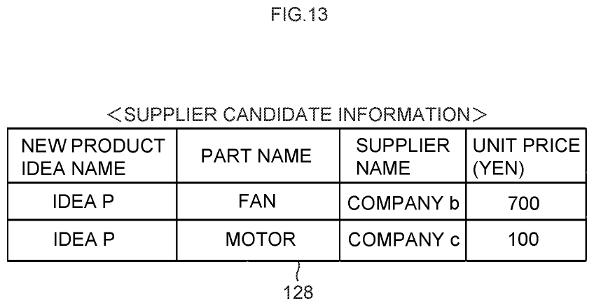

FIG. 13 is a schematic diagram illustrating an example of the supplier candidate information 128.

The supplier candidate information 128 is information indicating the supplier of the part selected by the supplier selection unit 113 and the unit price of the part. The supplier candidate information 128 here is information in which “NEW PRODUCT IDEA NAME”, “PART NAME”, “SUPPLIER NAME”, and “UNIT PRICE” are associated with one another.

The “NEW PRODUCT IDEA NAME” is the name of an idea of a new product such as “IDEA P” and “IDEA Q”. The “PART NAME” is the name of a part of a new product estimated by the supplier selection unit 113. The “UNIT PRICE” is a price per part specified from the supplier information 126.

The “SUPPLIER NAME” is the name of a supplier of a part selected by the supplier selection unit 113. The supplier selection unit 113 selects the supplier of each part on the basis of the “REQUIRED QUANTITY” in the new product parts information 127 (see FIG. 12) and the “SUPPLIABLE QUANTITY” in the supplier information 126 (see FIG. 11).

For example, the supplier selection unit 113 selects a supplier whose the “SUPPLIABLE QUANTITY” in the supplier information 126 (see FIG. 11) is equal to or more than the “REQUIRED QUANTITY” in the new product parts information 127. In the example of FIG. 11, the suppliable quantity of “FAN” of “COMPANY a” is “100”, but this quantity cannot satisfy the required quantity of “FAN” (5,000). On the other hand, the suppliable quantity of “FAN” of “COMPANY b” in FIG. 11 is “10,000”, which can satisfy the required quantity of “FAN” (5,000).

Therefore, the supplier selection unit 113 selects “COMPANY b” as the supplier of “FAN”, and records “COMPANY b” in “SUPPLIER NAME” of “FAN” in the supplier candidate information 128. According to the supplier information 126, the unit price of “FAN” of “COMPANY b” is “700 yen”. Therefore, the supplier selection unit 113 records “700 yen” in “UNIT PRICE” of “FAN” in the supplier candidate information 128.

In this manner, the supplier selection unit 113 selects the supplier of which the “SUPPLIABLE QUANTITY” is equal to or more than the required quantity, whereby it is possible to avoid a situation in which the supply of the part becomes insufficient.

Next, a parts procurement support method according to the present embodiment will be described.

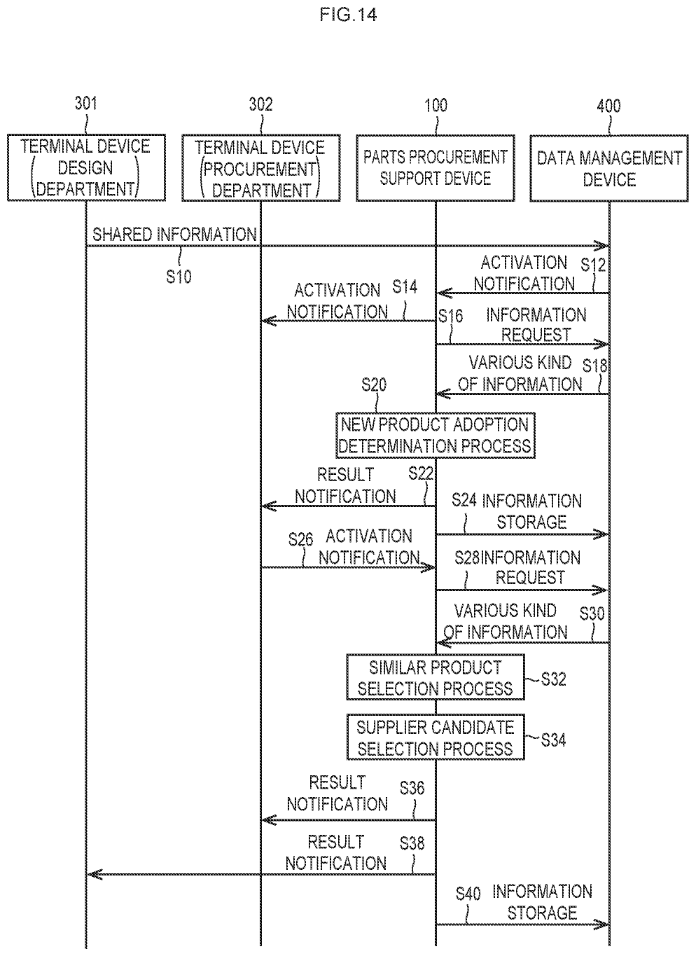

FIG. 14 is a sequence diagram illustrating an example of a parts procurement support method according to the present embodiment.

First, the terminal device 301 managed by the design department stores the shared information 121 in the data management device 400 (step S10), and the data management device 400 sends an activation notification to the parts procurement support device 100 (step S12).

Upon receipt of this activation notification, the parts procurement support device 100 is activated, and the parts procurement support device 100 sends the activation notification to the terminal device 302 managed by the procurement department (step S14).

Next, the adoption determination unit 111 of the parts procurement support device 100 requests various kinds of information from the data management device 400 (step S16). Examples of such information include the shared information 121, the evaluation information 122, the managing post information 141, and the threshold information 143.

Then, the adoption determination unit 111 acquires these kinds of information 121, 122, 141, and 143 from the data management device 400 and stores them in the storage unit 120 (step S18).

Next, on the basis of the acquired information 121, 122, 141, and 143, the adoption determination unit 111 performs a new product adoption determination process of determining whether a new product proposed by a person in charge of the design department is to be adopted, thereby to generate the above-described evaluation result information 123 (step S20). Details of the new product adoption determination process will be described later.

Next, the presentation unit 114 notifies the determination results in step S20 to the terminal device 302 managed by the procurement department (step S22). Thereafter, the adoption determination unit 111 stores the evaluation result information 123 in the data management device 400 (step S24), and the parts procurement support device 100 is stopped.

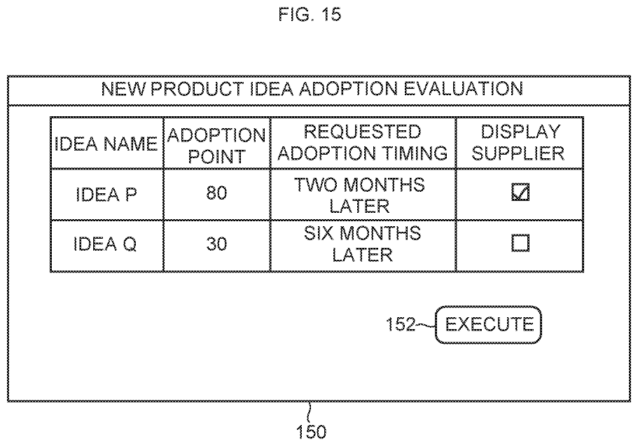

FIG. 15 is a diagram illustrating an example of the determination results presented on the terminal device 302 in step S22.

In the example of FIG. 15, the terminal device 302 having been notified of the determination results displays a screen 150 on which the evaluation result information 123 (see FIG. 7) is visualized on the display unit of the terminal device itself.

By viewing this screen 150, the person in charge of the procurement department can find that there is a possibility that the new product of “IDEA P” planned by the design department will be adopted as a commercial product two months later. The screen 150 also includes an execution button 152 for executing subsequent steps.

FIG. 14 will be referred to again. When the person in charge of the procurement department puts a check mark in the “DISPLAY SUPPLIER” on the screen 150 and presses the execution button 152, the terminal device 302 managed by the procurement department sends an activation notification to the parts procurement support device 100 (step S26). The parts procurement support device 100 may be automatically activated without using this activation notification.

Upon receipt of this activation notification, the parts procurement support device 100 is activated again, and the similar product selection unit 112 and the supplier selection unit 113 request various kinds of information from the data management device 400 (step S28). The information requested by the similar product selection unit 112 at this time includes the keyword information 125. The information requested by the supplier selection unit 113 includes the existing product parts information 124 and the supplier information 126.

Then, the similar product selection unit 112 acquires the keyword information 125 from the data management device 400 and stores the keyword information in the storage unit 120. The supplier selection unit 113 acquires the existing product parts information 124 and the supplier information 126 from the data management device 400, and stores them in the storage unit 120 (step S30).

Next, the similar product selection unit 112 performs a similar product selection process (step S32). The similar product selection process is a process of selecting an existing product similar to the new product determined to be adopted as a commercial product in step S20, and details thereof will be described later.

Next, the supplier selection unit 113 performs a supplier candidate selection process (step S34). The supplier candidate selection process is a process of selecting suppliers of parts constituting a new product, on the basis of the numbers of parts corresponding to the existing product selected in step S32 among the existing products included in the existing product parts information 124 (see FIG. 10). In the supplier candidate selection process, the supplier selection unit 113 generates the new product parts information 127 (see FIG. 12) and the supplier candidate information 128 (see FIG. 13). Details of the supplier candidate selection process will be described later.

Next, the presentation unit 114 notifies the terminal device 302 managed by the procurement department of the selection results including the new product parts information 127 (see FIG. 12) and the supplier candidate information 128 (see FIG. 13) (step S36).

The presentation unit 114 further notifies the terminal device 301 managed by the design department of the same selection results as those in step S36 (step S38).

Thereafter, the supplier selection unit 113 stores the new product parts information 127 (see FIG. 12) and the supplier candidate information 128 (see FIG. 13) in the data management device 400 (step S40).

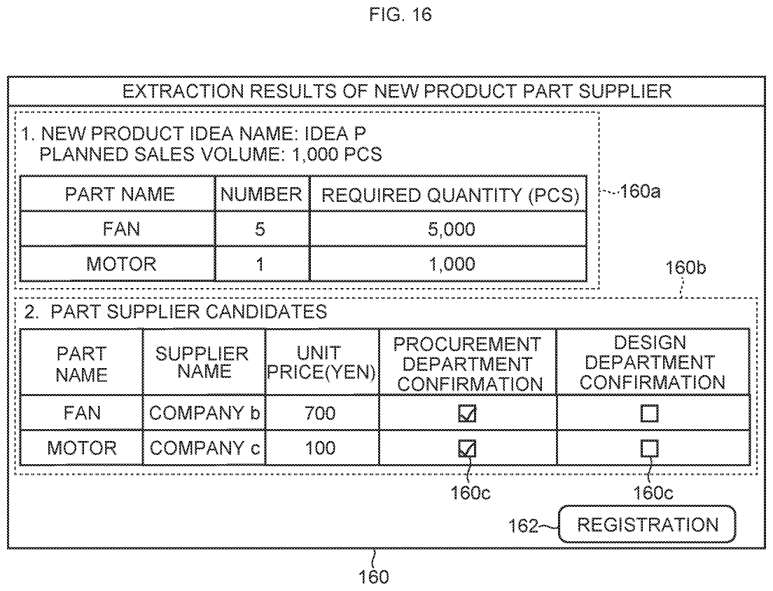

FIG. 16 is a diagram illustrating an example of selection results including existing products and suppliers presented on the terminal devices 301 and 302 in steps S36 and S38, respectively.

In the example of FIG. 16, each of the terminal devices 301 and 302 displays the screen 160 for displaying the selection results on the display unit of the own device.

The screen 160 includes a parts display area 160a and a supplier display area 160b. The parts display area 160a is an area in which the new product parts information 127 (see FIG. 12) is visualized. In this case, “IDEA P”, which is the name of the idea of a new product, and the planned sales volume “1,000” extracted from the shared information 121 are also displayed in the parts display area 160a. The supplier display area 160b is an area in which the supplier candidate information 128 (see FIG. 13) is visualized.

By viewing the screen 160 displayed on the terminal device 302, the person in charge of the procurement department can know that there is a possibility that the new product of “IDEA P” will be commercialized before the commercialization of the new product is decided, and can start selecting suppliers of parts constituting the new product.

In addition, since the suppliers of the parts are displayed in the supplier display area 160b of the screen 160, the person in charge of the procurement department can select part suppliers at an early stage before commercialization.

Furthermore, since the same screen 160 is displayed on the respective terminal devices 301 and 302 of the design department and the procurement department, persons in charge of the design department and the procurement department can share the information on parts of the new product and suppliers thereof.

The screen 160 includes check boxes 160c of “PROCUREMENT DEPARTMENT CONFIRMATION” and “DESIGN DEPARTMENT CONFIRMATION” and a registration button 162. The persons in charge of the design department and the procurement department may each put a check mark in the corresponding check box 160c and press the registration button 162 so that the parts procurement support device 100 records that the departments share the information.

This completes the basic process of the parts procurement support method according to the present embodiment.

Next, details of the new product adoption determination process (step S20), the similar product selection process (step S32), and the supplier candidate selection process (step S34) in FIG. 14 will be described.

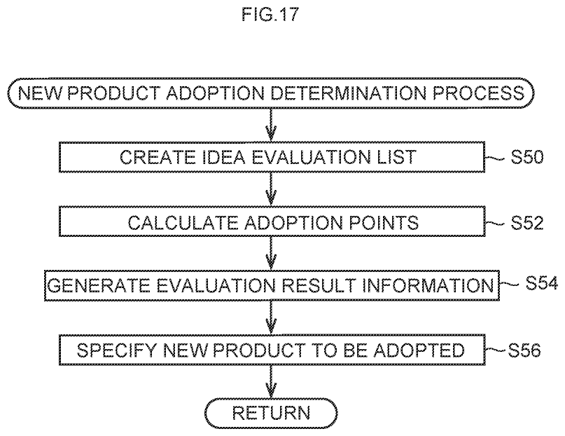

FIG. 17 is a flowchart illustrating an example of the new product adoption determination process.

First, the adoption determination unit 111 creates the idea evaluation list 142 of FIG. 5 (step S50). For example, the adoption determination unit 111 determines whether the “ITEM” of the evaluation information 122 in FIG. 3 is satisfied for each “CATEGORY” in the shared information 121 in FIG. 2. If any “ITEM” is satisfied, the adoption determination unit 111 records “1” in the idea evaluation list 142, and if any “ITEM” is not satisfied, the adoption determination unit 111 records “-”.

Next, the adoption determination unit 111 calculates adoption points on the basis of the idea evaluation list 142 (step S52). As described above, the adoption point is the sum of points (see FIG. 3) of the “ITEM” for which “1” is recorded in the idea evaluation list 142.

Next, the adoption determination unit 111 generates the evaluation result information 123 (see FIG. 7) including the calculated adoption points (step S54).

Thereafter, the adoption determination unit 111 determines a new product to be adopted as a commercial product, on the basis of the evaluation result information 123 and the threshold information 143 (step S56). For example, the adoption determination unit 111 determines that a new product of an idea whose adoption point is equal to or more than the threshold in the threshold information 143 (see FIG. 6) in the evaluation result information 123 is to be adopted as a commercial product. Thereafter, the process returns to the caller.

This completes the basic operation of the new product adoption determination process.

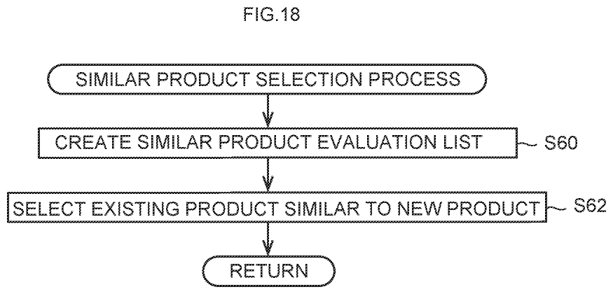

FIG. 18 is a flowchart illustrating an example of the similar product selection process.

First, the similar product selection unit 112 creates the similar product evaluation list 144 of FIG. 9, on the basis of the shared information 121 and the keyword information 125 (step S60).

As an example, the similar product selection unit 112 specifies rows in which an idea of a new product determined to be adopted as a commercial product is included in the “CATEGORY” among the rows of the shared information 121 (see FIG. 2). Then, the similar product selection unit 112 determines, for each existing product, whether the “KEYWORD” in the keyword information 125 has appeared in the “COMMENT” in each specified row. If the “KEYWORD” has appeared in the “COMMENT”, the similar product selection unit 112 records “1” in an entry corresponding to the existing product to be determined and the keyword in the similar product evaluation list 144. If the “KEYWORD” has not appeared, the similar product selection unit 112 records “-” in the corresponding entry.

Next, the similar product selection unit 112 selects an existing product similar to the new product determined to be adopted as a commercial product, on the basis of the similar product evaluation list 144 (step S62). For example, the similar product selection unit 112 selects an existing product having the largest number of “1s” among a plurality of existing products in the similar product evaluation list 144 as a product similar to the new product. Thereafter, the process returns to the caller.

This completes the basic operation of the similar product selection process.

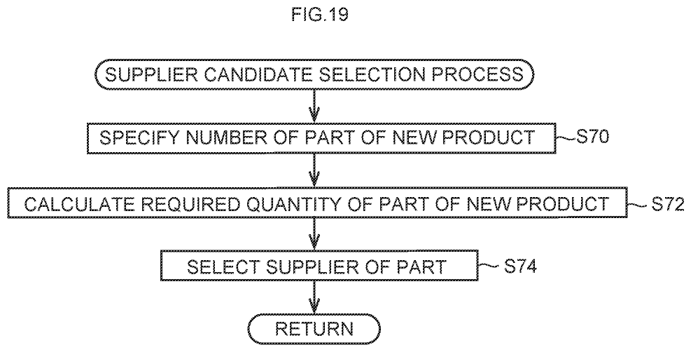

FIG. 19 is a flowchart illustrating an example of the supplier candidate selection process.

First, the supplier selection unit 113 determines the number of a part of the new product determined to be adopted as a commercial product (step S70). For example, the supplier selection unit 113 specifies the numbers of parts of existing product similar to the new product among the existing products in the existing product parts information 124 (see FIG. 10) as the numbers of parts of the new product.

Next, the supplier selection unit 113 calculates the required quantity of part of the new product (step S72). As an example, the supplier selection unit 113 specifies the planned production volume of the new product included in the comment of the shared information 121 (see FIG. 2), and calculates a value obtained by multiplying the planned production volume of the new product by the number of the part specified in step S70 as the required quantity. The supplier selection unit 113 also generates the new product parts information 127 (see FIG. 12) in which parts, the numbers of the parts, and the required quantities of the parts are associated with one another.

Next, the supplier selection unit 113 selects suppliers of the parts of the new product, on the basis of the supplier information 126 in FIG. 11 and the new product parts information 127 in FIG. 12 (step S74). For example, the supplier selection unit 113 selects, as suppliers of the parts, suppliers whose “SUPPLIABLE QUANTITY” in the supplier information 126 (see FIG. 11) is equal to or larger than the “REQUIRED QUANTITY” of the part in the new product parts information 127. The supplier selection unit 113 also generates the supplier candidate information 128 (see FIG. 13) including “SUPPLIER NAME” which is the name of the selected supplier.

In this example, the suppliers whose the suppliable quantity of the part is equal to or larger than the required quantity are selected, but the present embodiment is not limited thereto.

For example, the supplier selection unit 113 may acquire, via the network 200, company evaluation information (not illustrated) on suppliers evaluated by a company evaluation organization, and select suppliers on the basis of the company evaluation information. In this case, the supplier selection unit 113 selects suppliers having company evaluation information equal to or higher than a predetermined standard, without reference to the suppliable quantities of parts. Examples of such company evaluation information include ESG evaluation such as Dow Jones Sustainability Index (DJS), financial evaluation such as Return On Equity (ROE), customer satisfaction, and S & P ratings. The company evaluation information may be feedback evaluation or the Key Performance Indicator (KPI) improvement. For the ESG evaluation, not only the ESG evaluation as an index related to investment, but also the evaluation of the Sustainable Development Goals (SDGs) may be adopted, or the evaluations of environment, society, and governance may be adopted.

This completes the basic operation of the supplier candidate selection process.

According to the present embodiment described above, the similar product selection unit 112 selects an existing product similar to the new product at an early stage of design, on the basis of the shared information 121 and the keyword information 125 generated from the chat contents and the like in the design department (step S32). Therefore, the supplier selection unit 113 can select suppliers of parts of the new product at an early stage in step S34, on the basis of the numbers of parts of the selected existing product, the company evaluation information of the selected suppliers, and the like. This allows the person in charge of the procurement department to determine whether the prices of the parts scheduled to be procured are inexpensive in sufficient time at a stage sufficiently earlier by the procurement lead time than the production start time of the new product, for example.

Moreover, if the adoption determination unit 111 determines a new product is to be adopted as a commercial product, the similar product selection unit 112 selects an existing product similar to the new product as described above. Therefore, it is not necessary for the similar product selection unit 112 to select an existing product similar to a new product with low probability of being commercialized, so that the supplier selection unit 113 can select suppliers of parts of a new product with high probability of being commercialized.

### Second Embodiment

In the first embodiment, the supplier selection unit 113 specifies the planned production volume of a new product from the shared information 121, and selects suppliers whose suppliable quantity of parts can satisfy the planned production volume. On the other hand, in the present embodiment, a supplier selection unit 113 selects suppliers that can satisfy the target sales volume and the like set by the product planning department.

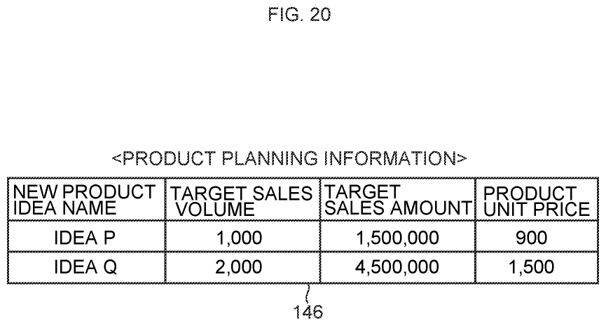

FIG. 20 is a schematic diagram illustrating an example of product planning information 146 created by the product planning department. As illustrated in FIG. 20, the product planning information 146 is information in which “NEW PRODUCT IDEA NAME”, “TARGET SALES VOLUME”, “TARGET SALES AMOUNT”, and “PRODUCT UNIT PRICE” are associated with one another. The product planning information 146 is stored in a storage unit 120 in advance by an administrator of a parts procurement support system 10, for example.

In step S72 (see FIG. 19), the supplier selection unit 113 selects the required quantity of a part of the new product on the basis of the product planning information 146. For example, the supplier selection unit 113 specifies a value obtained by multiplying the “TARGET SALES VOLUME” by the number of the part specified in step S70 as the required quantity of the part.

The supplier selection unit 113 then selects the supplier that can supply the required quantity of the part specified in this way, in step S74 (see FIG. 19).

This makes it possible to select suppliers of parts that can satisfy the target sales volume set by the product planning department.

The present embodiment is not limited thereto, and the supplier selection unit 113 may select suppliers on the basis of the “PRODUCT UNIT PRICE”. In this case, instead of step S72, the supplier selection unit 113 performs a step of calculating, for each part, an amount obtained by multiplying the unit price of the part in the supplier information 126 (see FIG. 11) by the number of the part specified in step S70. Furthermore, in that step, the supplier selection unit 113 calculates a total sum of the calculated amounts for all the parts constituting the new product.

Furthermore, in step S74, the supplier selection unit 113 selects a combination from among combinations of suppliers of each part in the supplier information 126 such that the calculated total amount does not exceed the unit price of the new product in the product planning information 146, (see FIG. 11). If there is a plurality of such combinations of suppliers, the supplier selection unit 113 may select the plurality of combinations.

This makes it possible to select suppliers of parts that do not exceed the unit price of the new product set by the product planning department.

### Third Embodiment

In the first embodiment, the presentation unit 114 presents part suppliers selected by the supplier selection unit 113 to the respective terminal devices 301 and 302 of the design department and the procurement department (steps S36 and S38), whereby the design department and the procurement department share the information.

On the other hand, in the present embodiment, in addition to a terminal device 301 of a design department, a presentation unit 114 presents various kinds of information to a terminal device managed by any of a product planning department, a sales strategy department, an intellectual property department, and a manufacturing department.

For example, the presentation unit 114 presents unit prices of parts in supplier candidate information 128 (see FIG. 13) to a terminal device managed by the product planning department. As a result, the person in charge of the product planning department can calculate the unit price of the new product, and check whether the new product is likely to be in an attractive price range at an early stage of design.

In addition, the presentation unit 114 may present an existing product similar to the new product selected in step S62 to a terminal device managed by the sales strategy department or the intellectual property department. As a result, the person in charge of the sales strategy department can investigate the sales situation of the existing product similar to the new product before the sales of the new product, and can prepare the sales strategy utilizing the strengths of the new product based on the investigation results. In addition, the person in charge of the intellectual property department can investigate the presence or absence of an intellectual property right of another company close to the existing product similar to the new product. Therefore, the person in charge can determine whether the new product may conflict with another company's intellectual property right at an early stage of design, and can take countermeasures at an early stage if determining that the new product may conflict with another company's intellectual property right.

The presentation unit 114 may further present parts in new product parts information 127 (see FIG. 12) to a terminal device managed by the manufacturing department. As a result, the person in charge of the manufacturing department can understand in advance how much production system should be prepared based on the parts constituting the new product, and can make personnel arrangements and equipment preparations at an early stage.

<Hardware Configuration>

Next, a hardware configuration of the parts procurement support device 100 according to the present embodiment will be described.

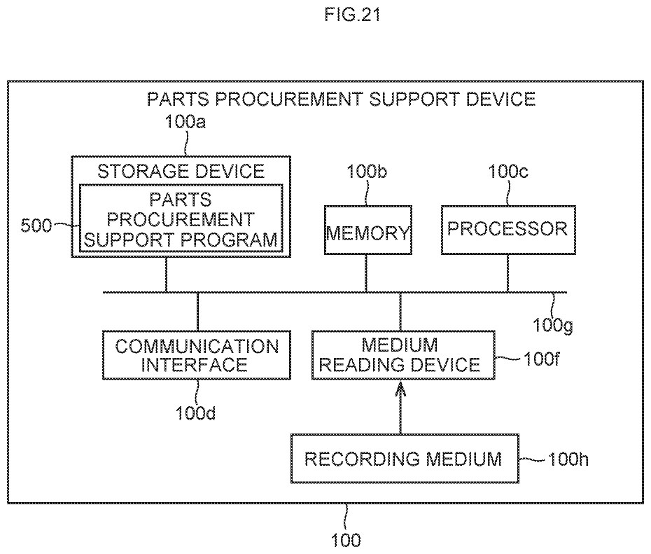

FIG. 21 is a diagram illustrating an example of the hardware configuration of the parts procurement support device 100 according to the present embodiment.

As illustrated in FIG. 21, the parts procurement support device 100 includes a storage device 100a, a memory 100b, a processor 100c, a communication interface 100d, and a medium reading device 100f. These units are connected to each other by a bus 100g.

The storage device 100a is a nonvolatile storage device such as a hard disk drive (HDD) or a solid state drive (SSD), and stores a parts procurement support program 500 according to the present embodiment.

The parts procurement support program 500 may be recorded in a computer-readable recording medium 100h, and the processor 100c may read the parts procurement support program 500 from the recording medium 100h.

Examples of the recording medium 100h include physical portable recording media such as a compact disc-read only memory (CD-ROM), a digital versatile disc (DVD), and a universal serial bus (USB) memory. A semiconductor memory such as a flash memory or a hard disk drive may be used as the recording medium 100h.

The parts procurement support program 500 may be stored in a device connected to a public line, the Internet, a local area network (LAN), or the like. In this case, the processor 100c may read and execute the parts procurement support program 500.

The memory 100b is hardware that temporarily stores data, such as a dynamic random access memory (DRAM), on which the parts procurement support program 500 is deployed.

The processor 100c is a central processing unit (CPU) or a graphical processing unit (GPU) that controls the functional units of the parts procurement support device 100. The processor 100c executes the parts procurement support program 500 in cooperation with the memory 100b, thereby implementing the processing unit 110 illustrated in FIG. 1.

The storage unit 120 in FIG. 1 is implemented by the storage device 100a and the memory 100b. The communication interface 100d is hardware such as a network interface card (NIC) for connecting the parts procurement support device 100 to the network 200. The communication interface 100d implements the communication unit 130 illustrated in FIG. 1.

The medium reading device 100f is hardware such as a USB reader for reading data from the recording medium 100h.

The advantageous effects described in the present specification are merely examples and are not limited, and other advantageous effects may be provided.

The present invention is not limited to the above-described embodiments, and includes various modifications. For example, each of the above-described embodiments has been described in detail in order to make the present invention easy to understand, and the present invention is not necessarily limited to embodiments including all the components described above. Some of the components of one embodiment can be replaced with components of another embodiment, and the components of an embodiment can be added to the components of another embodiment. It is possible to add, delete, and replace some of components to, from, and with others of the components in each embodiment.

Some or all of the above-described components, functions, processing units, processing means, and the like may be implemented by hardware designed with an integrated circuit, for example. The above-described components, functions, and the like may be implemented by software by a processor interpreting and executing programs for performing the functions. Information in programs, determination tables, and files for implementing the functions can be stored in a storage device such as a memory, an HDD, and an SSD, or a recording medium such as an integrated circuit (IC) card, a secure digital (SD) card, and a digital versatile disc (DVD). The control lines and the information lines indicate what is considered to be necessary for the description, and do not necessarily indicate all the control lines and the information lines on the product. In practice, it may be considered that almost all the components are connected to each other.

What is claimed is:

1. A parts procurement support device comprising:
a similar product selection unit configured to select an existing product similar to a new product on the basis of shared information regarding design of the new product and feature information indicating a feature of the existing product; and
a supplier selection unit configured to select a supplier of a part constituting the new product on the basis of parts information regarding a part of the selected existing product.

2. The parts procurement support device according to claim 1, further comprising
an adoption determination unit configured to determine whether the new product is to be adopted as a commercial product by evaluating a predetermined item included in the shared information, wherein
when it is determined that the new product is to be adopted as the commercial product, the similar product selection unit selects the existing product similar to the new product.

3. The parts procurement support device according to claim 2, wherein
the adoption determination unit executes a process comprising:
referring to evaluation information in which a numerical value indicating a possibility of the new product being adopted as a commercial product is associated with the predetermined item to obtain a sum of the numerical value corresponding to the predetermined item, and
determining that the new product is to be adopted when the sum is equal to or greater than a threshold, and determines that the new product is not to be adopted when the sum is less than the threshold.

4. The parts procurement support device according to claim 1, wherein
the feature information is information in which a plurality of the existing products and a plurality of first keywords are associated with each other, and
the similar product selection unit selects, as an existing product similar to the new product, the existing product having the largest number of first keywords matching second keywords appearing in the shared information, among the plurality of existing products.

5. The parts procurement support device according to claim 1, wherein the supplier selection unit selects the supplier capable of supplying required quantity of the part with reference to supplier information in which suppliable quantity of the part and the supplier are associated with each other.

6. The parts procurement support device according to claim 5, wherein
the parts information includes the number of a part constituting the existing product, and
the supplier selection unit specifies a value obtained by multiplying the number of the part by a planned production volume of the new product included in the shared information as the required quantity of the part.

7. The parts procurement support device according to claim 5, wherein
the parts information includes the number of a part constituting the existing product, and
the supplier selection unit specifies a value obtained by multiplying the number of the part by a target sales volume of the new product as the required quantity of the part.

8. The parts procurement support device according to claim 1, wherein
the parts information includes the number of a part constituting the existing product, and
the supplier selection unit executes a process comprising:
calculating an amount obtained by multiplying a unit price of the part constituting the existing product by the number of the part for all parts constituting the existing product, and
selecting, from among combinations of the suppliers of the parts, a combination of suppliers of which a sum of the amounts of all the parts constituting the existing product does not exceed a predetermined unit price of the new product.

9. The parts procurement support device according to claim 1, further comprising
a presentation unit configured to present, to a terminal device managed by any of a design department, a product planning department, a sales strategy department, an intellectual property department, and a manufacturing department, any of a unit price of the part at the supplier, the existing product similar to the new product, and the part constituting the new product.

10. The parts procurement support device according to claim 1, wherein
the shared information includes text extracted from any of a mail, a chat, and a telephone conversation.

11. A parts procurement support system comprising a parts procurement support device and a terminal device, wherein
the parts procurement support device includes
a similar product selection unit configured to select an existing product similar to a new product on the basis of shared information regarding design of the new product and feature information indicating a feature of the existing product,
a supplier selection unit configured to select a supplier of a part constituting the new product on the basis of parts information regarding a part of the selected existing product, and
a presentation unit configured to present the selected supplier to the terminal device.

12. A parts procurement support method for causing a computer to execute a process, the process comprising:
a step of selecting an existing product similar to a new product on the basis of shared information regarding design of the new product and feature information indicating a feature of the existing product; and
a step of selecting a supplier of a part constituting the new product on the basis of parts information regarding a part of the selected existing product.
